(19) United States
(12) Patent Application Publication
(10) Pub. No.: US 2013/0267407 A1
(43) Pub. Date: Oct. 10, 2013

(54) METHOD OF PREPARING METALLOCENE CATALYSTS

(71) Applicants: Bodo Richter, Hofheim (DE); Heike Gregorius, Koblenz (DE)

(72) Inventors: Bodo Richter, Hofheim (DE); Heike Gregorius, Koblenz (DE)

(73) Assignee: Basell Polyolefine GmbH, Wesseling (DE)

(21) Appl. No.: 13/994,018

(22) PCT Filed: Dec. 14, 2011
(86) PCT No.: PCT/EP2011/072688

§ 371 Date: Jun. 13, 2013

Related U.S. Application Data
(60) Provisional application No. 61/441,723, filed on Feb. 11, 2011.

(30) Foreign Application Priority Data
Dec. 15, 2010 (EP) 10015747.8

(51) Int. Cl. C08F 110/06

(52) U.S. Cl. CPC C08F 110/06
USPC 502/104; 502/152

(57) ABSTRACT

Methods of preparing silica-supported catalysts useful for olefin polymerization are described. The catalysts comprise a metallocene complex. An activator mixture made from a boron acid compound and methylalumoxane is combined with either: (i) the metallocenecomplex, followed by calcined or chemically treated silica to give a supported catalyst; or (ii) calcined or chemically treated silica, followed by the metallocenecomplex to give a supported catalyst. The methods provide active supported catalysts.

The invention relates to ways to prepare metallocene catalysts useful for polymerizing olefins.

While Ziegler-Natta catalysts are a mainstay for polyolefin manufacture, single-site catalysts represent the industry's future. These catalysts open possibility to produce polymers with improved physical properties. The improved properties include controlled molecular weight distribution, reduced low molecular weight extractables, enhanced incorporation of α-olefin comonomers, lower polymer density, controlled content and distribution of long-chain branching, and modified melt rheology and relaxation characteristics.

A well known kind of single-site catalyst leading to a variety of polyolefin products is a metallocene catalyst which generally is activated with MAO. In special processes, such as e.g. the Spheripol process this kind of catalyst systems tend to cause reactor fouling due to leaching of activated metallocene in the presence of alkyl aluminum, which is used as scavenger. Thus in these processes, MAO activated metallocene catalysts require the absence of any scavenger and therefore lack in catalyst mileage due to traces of poisons (H₂O, CO₂, CO etc.) in the polymerization process. Increasing the mileage capability and robustness of the metallocene MAO catalyst is most desirable to improve metallocene MAO catalyst efficiency.

Therefore, it is an object of the present invention to provide a particularly valuable method for preparing supported catalyst systems comprising metallocenes which provide high activity for polymerizing olefins without use of alkyl aluminum.

The invention relates to methods for preparing supported catalysts useful for polymerizing olefins. The catalysts comprise a metallocene complex that incorporates a cyclopentadienyl ligand. In the inventive method, a boron acid compound having Lewis acidity is first combined with excess alkylalumoxane to produce an activator mixture. This activator mixture is then combined with either: (i) the metallocene complex described above, followed by calcined or chemically treated silica to give a supported catalyst; or (ii) calcined or chemically treated silica, followed by the metallocene complex to give a supported catalyst. The supported catalysts allow efficient polymerization to produce polyolefins without leading to any leaching of activated metallocene.

Catalysts prepared by the method of the invention are particularly useful for polymerizing olefins. They comprise an activated metallocene complex, preferably, a complex of a transition metal of group 4 of the Periodic Table of the Elements. Group 4 metals include zirconium, titanium, and hafnium. Zirconium and hafnium are preferred. Zirconium is particularly preferred.

The first step in the inventive method involves preparation of an activator mixture. This mixture is produced by combining a boron acid compound having Lewis acidity with excess alkylalumoxane.

Suitable boron acid compounds are borinic acids and boronic acids, and mixtures thereof. Perfluorinated organoboron acid compounds are preferred. Specific examples include bis(pentafluorophenyl)borinic acid, pentafluorophenylboronic acid, and the like. Especially preferred is bis(pentafluorophenyl)borinic acid.

Suitable alkylalumoxanes are well known and many are commercially available as solutions in hydrocarbon solvents from Albemarle, Akzo Nobel, and other suppliers. Examples include methylalumoxane, ethylalumoxane, etc. Methylalumoxanes, such as MAO, MMAO, or PMAO are particularly preferred.

The alkylalumoxane is used in excess compared with the amount of boron acid compound. Preferably, the alkylalumoxane and boron acid compound are used in amounts that provide an aluminum to boron (Al/B) molar ratio within the range of 2 to 50, more preferably from 5 to 40, most preferably from 8 to 35.

In one method of the invention, the activator mixture is combined with a metallocene complex, followed by calcined or chemically treated silica to give the supported catalyst. In a second method, the order is reversed, i.e., the activator mixture is combined first with the calcined or chemically treated silica, followed by the metallocene complex.

Thus, suitable metallocene complexes include a cyclopentadienyl ligand.

The metallocenes suitable for the catalyst systems produced by the method of the present invention are metallocenes of transition metals of group 3, 4, 5 or 6 of the Periodic Table of the Elements, preferable of transition metals of group 4 of the Periodic Table of the Elements. More preferred are metallocene compounds having two different π-ligands.

Particular preference is given to catalyst systems based on metallocene compounds of the formula (I),

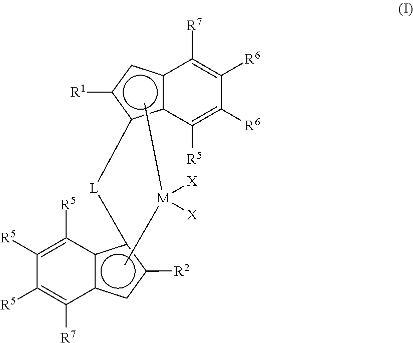

where
M is zirconium, hafnium or titanium, preferably zirconium,
X are identical or different and are each, independently of one another, hydrogen or halogen or an —R, —OR, —OSO₂CF₃, —OCOR, —SR, —NR₂ or —PR₂ group, where R is linear or branched C₁-C₂₀-alkyl, C₃-C₂₀-cycloalkyl which may be substituted by one or more C₁-C₁₀-alkyl radicals, C₆-C₂₀-aryl, C₇-C₂₀-alkylaryl or C₇-C₂₀-arylalkyl and may contain one or more heteroatoms of groups 13-17 of the Periodic Table of the Elements or one or more unsaturated bonds, preferably C₁-C₁₀-alkyl such as methyl, ethyl, n-propyl, isopropyl, n-butyl, isobutyl, sec-butyl, tert-butyl, n-pentyl, n-hexyl, n-heptyl or n-octyl or C₃-C₂₀-cycloalkyl such as cyclopentyl or cyclohexyl, where the two radicals X may also be joined to one another and preferably form a C₄-C₄₀-dienyl ligand, in particular a 1,3-dienyl ligand, or an —OR′O— group in which the substituent R′ is a divalent group selected from the group consisting of C₁-C₄₀-alkylidene, C₆-C₄₀-arylidene, C₇-C₄₀-alkylarylidene and C₇-C₄₀-arylalkylidene,
   where X is preferably a halogen atom or an —R or —OR group or the two radicals X form an —OR′O— group and X is particularly preferably chlorine or methyl,
L is a divalent bridging group selected from the group consisting of C₁-C₂₀-alkylidene radicals, C₃-C₂₀-cycloalkylidene radicals, C₆-C₂₀-arylidene radicals, C₇-C₂₀-alkylarylidene radicals and C₇-C₂₀-arylalkylidene radicals, which may contain heteroatoms of groups 13-17 of the Periodic Table of the Elements, or a silylidene group having up to 5 silicon atoms, e.g. —SiMe₂- or —SiPh₂-, where L preferably is a radical selected from the group consisting of —SiMe₂-, —SiPh₂-, —SiPhMe—, —SiMe(SiMe₃)—, —CH₂—, —(CH₂)₂—, —(CH₂)₃— and —C(CH₃)₂—,
R¹ is linear or branched C₁-C₂₀-alkyl, C₃-C₂₀-cycloalkyl which may be substituted by one or more C₁-C₁₀-alkyl radicals, C₆-C₂₀-aryl, C₇-C₂₀-alkylaryl or C₇-C₂₀-arylalkyl and may contain one or more heteroatoms of groups 13-17 of the Periodic Table of the Elements or one or more unsaturated bonds, where R¹ is preferably unbranched in the a position and is preferably a linear or branched C₁-C₁₀-alkyl group which is unbranched in the a position, in particular a linear C₁-C₄-alkyl group such as methyl, ethyl, n-propyl or n-butyl,
R² is a group of the formula —C(R³)₂R⁴, where
R³ are identical or different and are each, independently of one another, linear or branched C₁-C₂₀-alkyl, C₃-C₂₀-cycloalkyl which may be substituted by one or more C₁-C₁₀-alkyl radicals, C₆-C₂₀-aryl, C₇-C₂₀-alkylaryl or C₇-C₂₀-arylalkyl and may contain one or more heteroatoms of groups 13-17 of the Periodic Table of the Elements or one or more unsaturated bonds, or two radicals R³ may be joined to form a saturated or unsaturated C₃-C₂₀-ring,
   where R³ is preferably a linear C₁-C₁₀-alkyl group, and
R⁴ is hydrogen, linear or branched C₁-C₂₀-alkyl, C₃-C₂₀-cycloalkyl which may be substituted by one or more C₁-C₁₀-alkyl radicals, C₆-C₂₀-aryl, C₇-C₂₀-alkylaryl or C₇-C₂₀-arylalkyl and may contain one or more heteroatoms of groups 13-17 of the Periodic Table of the Elements or one or more unsaturated bonds,
   where R⁴ is preferably hydrogen,
R⁵ are identical or different and are each, independently of one another, hydrogen or halogen or linear or branched C₁-C₂₀-alkyl, C₃-C₂₀-cycloalkyl which may be substituted by one or more C₁-C₁₀-alkyl radicals, C₆-C₂₀-aryl, C₇-C₂₀-alkylaryl or C₇-C₂₀-arylalkyl and may contain one or more heteroatoms of groups 13-17 of the Periodic Table of the Elements or one or more unsaturated bonds,
   where R⁵ is preferably hydrogen or a linear or branched C₁-C₁₀-alkyl group, in particular hydrogen, and
R⁶ are identical or different and are each, independently of one another hydrogen, linear or branched C₁-C₂₀-alkyl, C₃-C₂₀-cycloalkyl which may be substituted by one or more C₁-C₁₀-alkyl radicals, C₆-C₂₀-aryl, C₇-C₂₀-alkylaryl or C₇-C₂₀-arylalkyl and may contain one or more heteroatoms of groups 13-17 of the Periodic Table of the Elements or one or more unsaturated bonds, or the two radicals R⁶ may be joined to form together with the atoms connecting them a saturated or unsaturated C₅-C₂₀ ring, where preferably R⁶ is hydrogen or two R⁶ preferably are joined to form a saturated or unsaturated C₅-C₁₄ ring,
R⁷ are identical or different and are each, independently of one another, halogen or linear or branched C₁-C₂₀-alkyl, C₃-C₂₀-cycloalkyl which may be substituted by one or more C₁-C₁₀-alkyl radicals, C₆-C₂₀-aryl, C₇-C₂₀-alkylaryl or C₇-C₂₀-arylalkyl and may contain one or more heteroatoms of groups 13-17 of the Periodic Table of the Elements or one or more unsaturated bonds,
   where R⁷ is preferably an aryl group of the formula (II),

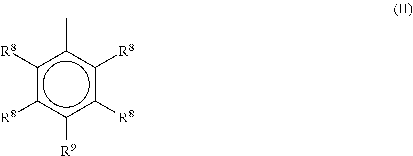

where
R⁸ are identical or different and are each, independently of one another, hydrogen or halogen or linear or branched C₁-C₂₀-alkyl, C₃-C₂₀-cycloalkyl which may be substituted by one or more C₁-C₁₀-alkyl radicals, C₆-C₂₀-aryl, C₇-C₂₀-alkylaryl or C₇-C₂₀-arylalkyl and may contain one or more heteroatoms of groups 13-17 of the Periodic Table of the Elements or one or more unsaturated bonds, or two radicals R⁸ may be joined to form a saturated or unsaturated C₃-C₂₀ ring,
   where R⁸ is preferably a hydrogen atom, and
R⁹ is hydrogen or halogen or linear or branched C₁-C₂₀-alkyl, C₃-C₂₀-cycloalkyl which may be substituted by one or more C₁-C₁₀-alkyl radicals, C₆-C₂₀-aryl, C₇-C₂₀-alkylaryl or C₇-C₂₀-arylalkyl and may contain one or more heteroatoms of groups 13-17 of the Periodic Table of the Elements or one or more unsaturated bonds,
   where R⁸ is preferably a branched alkyl group of the formula —C(R¹⁰)₃, where
R¹⁰ are identical or different and are each, independently of one another, a linear or branched C₁-C₆-alkyl group or two or three of the radicals R¹⁰ are joined to form one or more ring systems.

Examples of preferred metallocene compounds are
dimethylsilanediyl(2-methyl-4-(4′-tert-butylphenyl)indenyl)(2-isopropyl-4-(4″-tert-butylphenyl)indenyl)zirconium dichloride,
dimethylsilanediyl(2-methyl-4-(4′-tert-butylphenyl)indenyl)(2-isopropyl-4-(4″-tert-butylphenyl)indenyl)zirconium dimethyl,
dimethylsilanediyl (2-ethyl-4-(4′-tert-butylphenyl)indenyl)(2-isopropyl-4-(4″-tert-butylphenyl)indenyl)zirconium dichloride,
dimethylsilanediyl (2-ethyl-4-(4′-tert-butylphenyl)indenyl)(2-isopropyl-4-(4″-tert-butylphenyl)indenyl)zirconium dimethyl
dimethylsilanediyl (2-methyl-4-phenyl-1-indenyl)(2-isopropyl-4-(4″-tert-butylphenyl)-1-indenyl)zirconium dichloride,
dimethylsilanediyl (2-methyl-4-phenyl-1-indenyl)(2-isopropyl-4-(4″-tert-butylphenyl)-1-indenyl)zirconium dimethyl
dimethylsilanediyl (2-isopropyl-4-(4′-tert-butylphenyl)indenyl)(2-methyl-4,5-benzindenyl)zirconium dichloride,
dimethylsilanediyl (2-isopropyl-4-(4′-tert-butylphenyl)indenyl)(2-methyl-4,5-benzindenyl)zirconium dimethyl
dimethylsilanediyl (2-methyl-4-(4′-tert-butylphenyl)indenyl)(2-isopropyl-4-(1-naphthyl)indenyl)zirconium dichloride,
dimethylsilanediyl (2-methyl-4-(4′-tert-butylphenyl)indenyl)(2-isopropyl-4-(1-naphthyl)indenyl)zirconium dimethyl
dimethylsilanediyl(2-methyl-4-(4′-tert-butylphenyl)indenyl)(2-isopropyl-4-phenylindenyl)zirconium dichloride,
dimethylsilanediyl(2-methyl-4-(4′-tert-butylphenyl)indenyl)(2-isopropyl-4-phenylindenyl)zirconium dimethyl,
dimethylsilanediyl(2-ethyl-4-(4′-tert-butylphenyl)indenyl)(2-isopropyl-4-phenyl)indenyl)zirconium dichloride,
dimethylsilanediyl(2-ethyl-4-(4′-tert-butylphenyl)indenyl)(2-isopropyl-4-phenyl)indenyl)zirconium dichloride,
dimethylsilanediyl(2-isopropyl-4-(4′-tert-butylphenyl)indenyl)(2-methyl-4-(1-naphthyl)indenyl)zirconium dichloride,
dimethylsilanediyl(2-isopropyl-4-(4′-tert-butyl phenyl)indenyl)(2-methyl-4-(1-naphthyl)indenyl)zirconium dimethyl and mixtures thereof.

Catalysts made by the method of the invention are preferably supported on silica. The silica generally has a surface area in the range of about 10 to about 1000 m²/g, preferably from about 50 to about 800 m²/g and more preferably from about 200 to about 700 m²/g. Preferably, the pore volume of the silica is in the range of about 0.05 to about 4.0 mL/g, more preferably from about 0.08 to about 3.5 mL/g, and most preferably from about 0.1 to about 3.0 mL/g. Preferably, the average particle size of the silica is in the range of about 1 to about 500 μm, more preferably from about 2 to about 200 μm, and most preferably from about 2 to about 45 μm. The average pore diameter is typically in the range of about 0.05 to about 10 μm, preferably about 0.1 to about 5 μm, and most preferably about

0.2 to about 3.5 μm.

The silica is calcined, chemically treated, or both prior to use to reduce the concentration of surface hydroxyl groups. Calcination involves heating the support in a dry atmosphere at elevated temperature, preferably greater than 200° C., more preferably greater than 500° C., and most preferably from about 250 to about 800° C., prior to use. A variety of different chemical treatments can be used, including reaction with organoaluminum, -magnesium, -silicon, or -boron acid compounds. See, for example, the techniques described in U.S. Pat. No. 6,211,311, the teachings of which are incorporated herein by reference. Preferably, the silica is simply calcined prior to use.

Although there are many ways to combine complexes and activators, it is usually far from clear which methods will prove most satisfactory for a particular type of olefin polymerization catalyst. We surprisingly found that metallocene complexes are effectively activated using combinations of boron acid compounds and alkylalumoxanes when the activator components are precombined. Later combination with complex and calcined or chemically treated silica as outlined above provides catalysts with excellent activities for polymerizing olefins.

The following examples merely illustrate the invention. Those skilled in the art will recognize many variations that are within the spirit of the invention and scope of the claims.

### EXAMPLES

The weight average molar mass M_{w} and the molar mass distribution M_{w}/Mₙ were determined by gel permeation chromatography (GPC) at 145° C. in 1,2,4-trichlorobenzene using a GPC apparatus 150C from Waters. The data were evaluated using the Win-GPC software from HS-Entwicklungsgesellschaft für wissenschaftliche Hard- and Software mbH, Ober-Hilbersheim. Calibration of the columns was carried out by means of polypropylene standards having molar masses of from 100 to 10⁷ g/mol.

The melting points were determined by means of DSC (differential scanning calorimetry). The measurement was carried out in accordance with ISO standard 3146 using a first heating at a heating rate of 20° C. per minute to 200° C., a dynamic crystallization at a cooling rate of 20° C. per minute down to 25° C. and a second heating at a heating rate of 20° C. per minute back to 200° C. The melting point is then the temperature at which the enthalpy vs. temperature curve measured in the second heating displays a maximum.

### Example 1

### a) Synthesis of the Modified MAO

80 ml of MAO (30 wt % in toluene) were diluted with 100 ml of toluene and cooled to 0° C. In a separate flask, 18.4 g of bis(pentafluorophenyl)borinic acid were dissolved in 250 ml of toluene and added to the MAO/toluene solution in such a way, that the reaction temperature did not exceed 2° C. After complete addition of the bis(pentafluorophenyl)borinic acid the reaction mixture was filtered after being stirred for another hour at 0° C. The filtrate was kept over night in a refrigerator at 4° C.

### b) Synthesis of the Metallocene Catalyst A

10 g of silica support (Grace XPO2326, dried at 130° C. for 6 h) were suspended in 100 ml of toluene. The suspension was cooled to 0° C. and treated with 130 ml of the modified MAO solution described in Example 1a. During the addition, the reaction temperature was kept at 0° C. and afterwards raised to 25° C. After continuous stirring for 1 hour, the suspension was filtered and washed 3 times with 100 ml portions of toluene and again suspended in 100 ml of toluene. In a separate flask 248 mg of rac-dimethyl-silanediyl(2-methyl-4-(4′-tert-butylphenyl)indenyl)(2-isopropyl-4-(4′-tertbutyl-phenyl)indenyl)zirconium dimethyl were dissolved in 40 ml of toluene and at ambient temperature treated with 13 ml of the modified MAO solution described in Example 1a. The reaction mixture was stirred for 1 hour at ambient temperature and after that added to the silica support suspension at 15° C. The temperature was raised to 40° C. and stirred for 2 hours. Subsequently the suspension was filtered, suspended in 100 ml of toluene, stirred for 30 min at 60° C. This procedure was repeated 2 times. At last the remaining solid was suspended in 100 ml of n-heptane, stirred for 30 min at 60° C. and filtered. The residue was dried in vacuum until its weight remained constant. 19 g of a free flowing powder were obtained.

### c) Polymerization

A dry 14 l reactor was flushed 3 times with nitrogen and 3 times with propylene. 10 ml (19 mmol) of a 1.9 M triisobutylaluminum solution in heptane were placed in the reactor, which was subsequently charged with 306 mg of hydrogen and 2.5 kg of propylene at 30° C. A suspension of 85 mg of neat catalyst A prepared in example 1b) in 2 ml of hexane were subsequently rinsed into the reactor with 1 kg of propylene. The reaction temperature was set at 25° C. for 10 min and subsequently raised to 65° C. at which the polymerization occurred for 1 hour. The reaction was stopped by venting the remaining propylene. 2280 g of a finely divided polymer were obtained. The interior walls of the reactor displayed no deposits. The catalyst activity was 26.8 kg of PP/g of catalyst solid per hour. The polypropylene obtained had the following properties: M_{w}=274.000 g/mol, M_{w}/Mₙ=3.7, melting point=156° C.

### Example 2

### a) Synthesis of the Modified MAO

55 ml of MAO (30 wt % in toluene) were diluted with 150 ml of toluene and cooled to 0° C. In a separate flask, 6.3 g of bis(pentafluorophenyl)borinic acid were dissolved in 90 ml of toluene and added to the MAO/toluene solution in such a way, that the reaction temperature did not exceed 2° C. After complete addition of the bis(pentafluorophenyl)borinic acid the reaction mixture was filtered after being stirred for another hour at 0° C. The filtrate was kept over night in a refrigerator at 4° C.

### b) Synthesis of the Metallocene Catalyst B

10 g of silica support (Grace XPO2326, dried at 130° C. for 6 h) were suspended in 100 ml of toluene. The suspension was cooled to 0° C. and treated with 153 ml of the modified MAO solution described in Example 2a. During the addition, the reaction temperature was kept at 0° C. and afterwards raised to 25° C. After continuous stirring for 1 hour, the suspension was filtered and washed 3 times with 100 ml portions of toluene and again suspended in 100 ml of toluene. In a separate flask 248 mg of rac-dimethylsilanediyl(2-methyl-4-(4′-tert-butylphenyl)indenyl)(2-isopropyl-4-(4′-tetrbutylphenyl)indenyl)zirconium dimethyl were dissolved in 40 ml of toluene and at ambient temperature treated with 15.3 ml of the modified MAO solution described in Example 2a. The reaction mixture was stirred for 1 hour at ambient temperature and after that added to the silica support suspension at 15° C. The temperature was raised to 40° C. and stirred for 2 hours. Subsequently the suspension was filtered, suspended in 100 ml of toluene, stirred for 30 min at 60° C. This procedure was repeated 2 times. The residue was dried in vacuum until its weight remained constant. 15 g of a free flowing powder were obtained.

### c) Polymerization

A dry 14 l reactor was flushed 3 times with nitrogen and 3 times with propylene and subsequently charged with 306 mg of hydrogen and 2.5 kg of propylene at 30° C. A suspension of 166 mg of neat catalyst B prepared in example 2b) in 2 ml of hexane were subsequently rinsed into the reactor with 1 kg of propylene. The reaction temperature was set at 25° C. for 10 min and subsequently raised to 65° C. at which the polymerization occurred for 1 hour. The reaction was stopped by venting the remaining propylene. 1380 g of a finely divided polymer were obtained. The interior walls of the reactor displayed no deposits. The catalyst activity was 8.3 kg of PP/g of catalyst solid per hour. The polypropylene obtained had the following properties: M_{w}=146.000 g/mol, M_{w}/Mₙ=3.3, melting point=154° C.

### Example 3

### a) Synthesis of the Modified MAO

55 ml of MAO (30 wt % in toluene) were diluted with 150 ml of toluene and cooled to 0° C. In a separate flask, 3.15 g of bis(pentafluorophenyl)borinic acid were dissolved in 90 ml of toluene and added to the MAO/toluene solution in such a way, that the reaction temperature did not exceed 2° C. After complete addition of the bis(pentafluorophenyl)borinic acid the reaction mixture was filtered after being stirred for another hour at 0° C. The filtrate was kept over night in a refrigerator at 4° C.

### b) Synthesis of the Metallocene Catalyst C

10 g of silica support (Grace XPO2326, dried at 130° C. for 6 h) were suspended in 100 ml of toluene. The suspension was cooled to 0° C. and treated with 115 g of the modified MAO solution described in Example 3a. During the addition, the reaction temperature was kept at 0° C. and afterwards raised to 25° C. After continuous stirring for 1 hour, the suspension was filtered and washed 3 times with 100 ml portions of toluene and again suspended in 100 ml of toluene. In a separate flask 248 mg of rac-dimethylsilanediyl(2-methyl-4-(4′-tert-butylphenyl)indenyl)(2-isopropyl-4-(4′-tetrbutylphenyl)indenyl)zirconium dimethyl were dissolved in 40 ml of toluene and at ambient temperature treated with 11.5 g of the modified MAO solution described in Example 3a. The reaction mixture was stirred for 1 hour at ambient temperature and after that added to the silica support suspension at 15° C. The temperature was raised to 40° C. and stirred for 2 hours. Subsequently the suspension was filtered, suspended in 100 ml of toluene, stirred for 30 min at 60° C. This procedure was repeated 2 times. The residue was dried in vacuum until its weight remained constant. 15 g of a free flowing powder were obtained.

### c) Polymerization

A dry 14 l reactor was flushed 3 times with nitrogen and 3 times with propylene. 10 ml (19 mmol) of a 1.9 M triisobutylaluminum solution in heptane were placed in the reactor, which was subsequently charged with 306 mg of hydrogen and 2.5 kg of propylene at 30° C. A suspension of 93 mg of neat catalyst C prepared in example 2b) in 2 ml of hexane were subsequently rinsed into the reactor with 1 kg of propylene. The reaction temperature was set at 25° C. for 10 min and subsequently raised to 65° C. at which the polymerization occurred for 1 hour. The reaction was stopped by venting the remaining propylene. 1917 g of a finely divided polymer were obtained. The interior walls of the reactor displayed no deposits. The catalyst activity was 20.6 kg of PP/g of catalyst solid per hour. The polypropylene obtained had the following properties: M_{w}=175.000 g/mol, M_{w}/Mₙ=2.5, melting point=156° C.

### Example 4

### a) Synthesis of the Modified MAO

30 ml of MAO (30 wt % in toluene) were diluted with 50 ml of toluene and cooled to 0° C. In a separate flask, 6.9 g of bis(pentafluorophenyl)borinic acid were dissolved in 150 ml of toluene and added to the MAO/toluene solution in such a way, that the reaction temperature did not exceed 2° C. After complete addition of the bis(pentafluorophenyl)borinic acid the reaction mixture was filtered after being stirred for another hour at 0° C. The filtrate was kept over night in a refrigerator at 4° C.

### b) Synthesis of the Metallocene Catalyst D

15 g of silica support (Grace XPO2326, dried at 130° C. for 6 h) were suspended in 100 ml of toluene. The suspension was cooled to 0° C. and treated with 165 g of the modified MAO solution described in Example 4a. During the addition, the reaction temperature was kept at 0° C. and afterwards raised to 25° C. After continuous stirring for 1 hour, the suspension was filtered and washed 3 times with 100 ml portions of toluene and again suspended in 100 ml of toluene. In a separate flask 316 mg of rac-dimethylsilanediyl(2-methyl-4-(4′-tert-butylphenyl)indenyl)(2-isopropyl-4-(4′-tetrbutylphenyl)indenyl)zirconium dimethyl were dissolved in 50 ml of toluene and at ambient temperature treated with 21.4 g of the modified MAO solution described in Example 4a. The reaction mixture was stirred for 1 hour at ambient temperature and after that added to the silica support suspension at 15° C. The temperature was raised to 40° C. and stirred for 2 hours. Subsequently the suspension was filtered, suspended in 100 ml of toluene, stirred for 30 min at 60° C. This procedure was repeated 2 times. The residue was dried in vacuum until its weight remained constant. 23 g of a free flowing powder were obtained.

### c) Polymerization

A dry 14 l reactor was flushed 3 times with nitrogen and 3 times with propylene. 10 ml (19 mmol) of a 1.9 M triisobutylaluminum solution in heptane were placed in the reactor, which was subsequently charged with 306 mg of hydrogen and 2.5 kg of propylene at 30° C. A suspension of 101 mg of neat catalyst D prepared in example 4b) in 2 ml of hexane were subsequently rinsed into the reactor with 1 kg of propylene. The reaction temperature was set at 25° C. for 10 min and subsequently raised to 65° C. at which the polymerization occurred for 1 hour. The reaction was stopped by venting the remaining propylene. 1730 g of a finely divided polymer were obtained. The interior walls of the reactor displayed no deposits. The catalyst activity was 17.1 kg of PP/g of catalyst solid per hour. The polypropylene obtained had the following properties: M_{w}=196.000 g/mol, M_{w}/Mₙ=3.0, melting point=156° C.

### Example 5

### a) Synthesis of the Modified MAO

68.5 ml of MAO (30 wt % in toluene) were diluted with 100 ml of toluene and cooled to 0° C. In a separate flask, 7.85 g of bis(pentafluorophenyl)borinic acid were dissolved in 200 ml of toluene and added to the MAO/toluene solution in such a way, that the reaction temperature did not exceed 2° C. After complete addition of the bis(pentafluorophenyl)borinic acid the reaction mixture was filtered after being stirred for another hour at 0° C. The filtrate was kept over night in a refrigerator at 4° C.

### b) Synthesis of the Metallocene Catalyst E

15 g of silica support (Grace XPO2326, dried at 130° C. for 6 h) were suspended in 100 ml of toluene. The suspension was cooled to 0° C. and treated with 116 g of the modified MAO solution described in Example 5a. During the addition, the reaction temperature was kept at 0° C. and afterwards raised to 25° C. After continuous stirring for 1 hour, the suspension was filtered and washed 3 times with 100 ml portions of toluene and again suspended in 100 ml of toluene. In a separate flask 315 mg of rac-dimethylsilanediyl(2-methyl-4-(4′-tert-butylphenyl)indenyl)(2-isopropyl-4-(4′-tetrbutylphenyl)indenyl)zirconium dimethyl were dissolved in 50 ml of toluene and at ambient temperature treated with 15.2 g of the modified MAO solution described in Example 5a. The reaction mixture was stirred for 1 hour at ambient temperature and after that added to the silica support suspension at 15° C. The temperature was raised to 40° C. and stirred for 2 hours. Subsequently the suspension was filtered, suspended in 100 ml of toluene, stirred for 30 min at 40° C. This procedure was repeated 2 times. The residue was dried in vacuum until its weight remained constant. 24 g of a free flowing powder were obtained.

### c) Polymerization

A dry 14 l reactor was flushed 3 times with nitrogen and 3 times with propylene. 10 ml (19 mmol) of a 1.9 M triisobutylaluminum solution in heptane were placed in the reactor, which was subsequently charged with 306 mg of hydrogen and 2.5 kg of propylene at 30° C. A suspension of 82 mg of neat catalyst E prepared in example 4b) in 2 ml of hexane were subsequently rinsed into the reactor with 1 kg of propylene. The reaction temperature was set at 25° C. for 10 min and subsequently raised to 65° C. at which the polymerization occurred for 1 hour. The reaction was stopped by venting the remaining propylene. 1761 g of a finely divided polymer were obtained. The interior walls of the reactor displayed no deposits. The catalyst activity was 21.5 kg of PP/g of catalyst solid per hour. The polypropylene obtained had the following properties: M_{w}=197.000 g/mol, M_{w}/Mₙ=3.1, melting point=156° C.

### Comparative Example 1

### a) Synthesis of the Metallocene Catalyst F

Catalyst F corresponds to catalyst A, but without borinic acid.

### b) Polymerization

A dry 14 l reactor was flushed 3 times with nitrogen and 3 times with propylene. 10 ml (19 mmol) of a 1.9 M triisobutylaluminum solution in heptane were placed in the reactor, which was subsequently charged with 306 mg of hydrogen and 2.5 kg of propylene at 30° C. A suspension of 158 mg of neat catalyst F in 2 ml of hexane was subsequently rinsed into the reactor with 1 kg of propylene. The reaction temperature was set at 25° C. for 10 min and subsequently raised to 65° C. at which the polymerization occurred for 1 hour. The reaction was stopped by venting the remaining propylene. 2366 g of a finely divided polymer were obtained. The interior walls of the reactor displayed no deposits. The catalyst activity was 15.0 kg of PP/g of catalyst solid per hour. The polypropylene obtained had the following properties: M_{w}=244.000 g/mol, M_{w}/Mₙ=3.2, melting point=156° C.

### c) Polymerization without Scavenger

A dry 14 l reactor was flushed 3 times with nitrogen and 3 times with propylene and subsequently charged with 306 mg of hydrogen and 2.5 kg of propylene at 30° C. A suspension of 459 mg of neat catalyst F prepared in the comparative example 1 in 2 ml of hexane was subsequently rinsed into the reactor with 1 kg of propylene. The reaction temperature was set at 25° C. for 10 min and subsequently raised to 65° C. at which the polymerization occurred for 1 hour. The reaction was stopped by venting the remaining propylene. 2300 g of a finely divided polymer were obtained. The interior walls of the reactor displayed no deposits. The catalyst activity was 5.0 kg of PP/g of catalyst solid per hour. The polypropylene obtained had the following properties: M_{w}=282.000 g/mol, M_{w}/Mₙ=3.7, melting point=156° C.

### Example 6

### a) Synthesis of the Modified MAO

50 ml of MAO (30 wt % in toluene) were diluted with 200 ml of toluene and cooled to 0° C. In a separate flask, 11.5 g of bis(pentafluorophenyl)borinic acid were dissolved in 100 ml of toluene and added to the MAO/toluene solution in such a way, that the reaction temperature did not exceed 2° C. After complete addition of the bis(pentafluorophenyl)borinic acid the reaction mixture was filtered after being stirred for another hour at 0° C. The filtrate was kept over night in a refrigerator at 4° C.

### b) Synthesis of the Metallocene Catalyst G

18 g of silica support (Grace XPO2485, dried at 130° C. for 6 h) were suspended in 100 ml of toluene. The suspension was cooled to 0° C. and treated with 304 ml of the modified MAO solution described in Example 6a. During the addition, the reaction temperature was kept at 0° C. and afterwards raised to 25° C. After continuous stirring for 1 hour, the suspension was filtered and washed 3 times with 100 ml portions of toluene and again suspended in 100 ml of toluene. In a separate flask 347 mg of rac-dimethylsilanediyl-bis(2-methyl-(4-phenyl)indenyl)zirconium dichloride were suspended in 41 ml of toluene and at ambient temperature treated with 32 ml of the modified MAO solution described in Example 6a. The reaction mixture was stirred for 1 hour at ambient temperature and after that added to the silica support suspension at 15° C. The temperature was raised to 40° C. and stirred for 2 hours. Subsequently the suspension was filtered, suspended in 100 ml of toluene, stirred for 30 min at 60° C. At last the remaining solid was suspended in 100 ml of n-heptane, stirred for 30 min at 60° C. and filtered. The residue was dried in vacuum until its weight remained constant. 32 g of a free flowing powder were obtained.

### c) Polymerization

A dry 14 l reactor was flushed 3 times with nitrogen and 3 times with propylene. 10 ml (19 mmol) of a 1.9 M triisobutylaluminum solution in heptane were placed in the reactor, which was subsequently charged with 306 mg of hydrogen and 2.5 kg of propylene at 30° C. A suspension of 98 mg of neat catalyst G prepared in example 6b) in 2 ml of hexane were subsequently rinsed into the reactor with 1 kg of propylene. The reaction temperature was set at 25° C. for 10 min and subsequently raised to 65° C. at which the polymerization occurred for 1 hour. The reaction was stopped by venting the remaining propylene. 2719 g of a finely divided polymer were obtained. The interior walls of the reactor displayed no deposits. The catalyst activity was 27.7 kg of PP/g of catalyst solid per hour. The polypropylene obtained had the following properties: M_{w}=544.000 g/mol, M_{w}/Mₙ=4.8, melting point=150° C.

| | | [Al] | [B] | [Zr] | | H₂ | Activity | Mw | Mw/ | Tm₂ |
|---|---|---|---|---|---|---|---|---|---|---|
| Example | catalyst | wt. % | wt..% | μmol/g | TiBA | mg | Kg/gh | g/mol | Mn | ° C. |
| 1c | A | 14.6 | 0.78 | 40 | yes | 306 | 26.8 | 274.000 | 3.7 | 156 |
| 2c | B | 16.6 | 0.44 | 40 | no | 306 | 8.3 | 146.000 | 3.3 | 154 |
| 3c | C | 17.9 | 0.24 | 40 | yes | 306 | 20.6 | 175.000 | 2.5 | 156 |
| 4c | D | 12.1 | 0.65 | 30 | yes | 306 | 17.1 | 196.000 | 3.0 | 156 |
| 5c | E | 13.6 | 0.36 | 30 | yes | 306 | 21.5 | 197.000 | 3.1 | 156 |
| CE 1b | F | 18.7 | 0 | 40 | yes | 306 | 15.0 | 244.000 | 3.2 | 156 |
| CE 1c | F | 18.7 | 0 | 40 | no | 306 | 5.0 | 282.000 | 3.7 | 156 |
| 6c | G | 14.6 | 0.79 | 30 | yes | 306 | 27.7 | 544.000 | 4.8 | 150 |

1. A method of preparing a supported catalyst useful for polymerizing olefins, comprising:
(a) combining a boron acid compound with excess alkylalumoxane to produce an activator mixture; and
(b) combining the activator mixture with either:
(i) a metallocene complex, followed by calcined or chemically treated silica to give the supported catalyst; or
(ii) calcined or chemically treated silica, followed by a metallocene complex to give the supported catalyst.

2. The method according to claim 1 wherein the alkylalumoxane and boron acid compound are used in amounts that provide an aluminum to boron (Al/B) molar ratio within the range of 2:1 to 50:1.

3. The method according to claim 2 wherein the Al/B molar ratio is within the range of 5:1 to 40:1.

4. The method according to claim 1 wherein the alkylalumoxane is methyl-alumoxane.

5. The method according to claim 1 wherein the boron acid compound is selected from the group consisting of boronic acids and borinic acids.

6. The method according to claim 1 wherein the metallocene complex corresponds to formula (I), 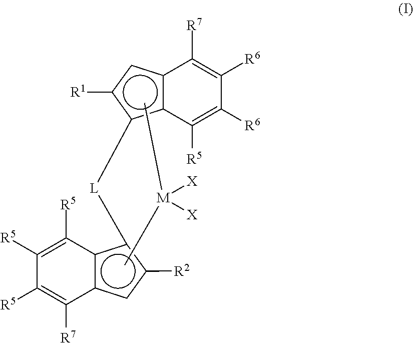
where
M is zirconium, hafnium or titanium,
X are identical or different and are each, independently of one another, hydrogen or halogen or an —R, —OR, —OSO₂CF₃, —OCOR, —SR, —NR₂ or —PR₂ group, where R is linear or branched C₁-C₂₀-alkyl, C₃-C₂₀-cycloalkyl which may be substituted by one or more C₁-C₁₀-alkyl radicals, or C₃-C₂₀-cycloalkyl, C₆-C₂₀-aryl, C₇-C₂₀-alkylaryl or C₇-C₂₀-arylalkyl and may contain one or more heteroatoms of groups 13-17 of the Periodic Table of the Elements or one or more unsaturated bonds, where the two radicals X may also be joined to one another,
L is a divalent bridging group selected from the group consisting of C₁-C₂₀-alkylidene radicals, C₃-C₂₀-cycloalkylidene radicals, C₆-C₂₀-arylidene radicals, C₇-C₂₀-alkylarylidene radicals and C₇-C₂₀-arylalkylidene radicals, which may contain heteroatoms of groups 13-17 of the Periodic Table of the Elements, or a silylidene group having up to 5 silicon atoms,
R¹ is linear or branched C₁-C₂₀-alkyl, C₃-C₂₀-cycloalkyl which may be substituted by one or more C₁-C₁₀-alkyl radicals, C₆-C₂₀-aryl, C₇-C₂₀-alkylaryl or C₇-C₂₀-arylalkyl and may contain one or more heteroatoms of groups 13-17 of the Periodic Table of the Elements or one or more unsaturated bonds,
R² is a group of the formula —C(R³)₂R⁴, where
R³ are identical or different and are each, independently of one another, linear or branched C₁-C₂₀-alkyl, C₃-C₂₀-cycloalkyl which may be substituted by one or more C₁-C₁₀-alkyl radicals, C₆-C₂₀-aryl, C₇-C₂₀-alkylaryl or C₇-C₂₀-arylalkyl and may contain one or more heteroatoms of groups 13-17 of the Periodic Table of the Elements or one or more unsaturated bonds, or two radicals R³ may be joined to form a saturated or unsaturated C₃-C₂₀-ring, and
R⁴ is hydrogen, or linear or branched C₁-C₂₀-alkyl, C₃-C₂₀-cycloalkyl which may be substituted by one or more C₁-C₁₀-alkyl radicals, C₆-C₂₀-aryl, C₇-C₂₀-alkylaryl or C₇-C₂₀-arylalkyl and may contain one or more heteroatoms of groups 13-17 of the Periodic Table of the Elements or one or more unsaturated bonds,
R⁵ are identical or different and are each, independently of one another, hydrogen or halogen or linear or branched C₁-C₂₀-alkyl, C₃-C₂₀-cycloalkyl which may be substituted by one or more C₁-C₁₀-alkyl radicals, C₆-C₂₀-aryl, C₇-C₂₀-alkylaryl or C₇-C₂₀-arylalkyl and may contain one or more heteroatoms of groups 13-17 of the Periodic Table of the Elements or one or more unsaturated bonds, and
R⁶ are identical or different and are each, independently of one another hydrogen, linear or branched C₁-C₂₀-alkyl, C₃-C₂₀-cycloalkyl which may be substituted by one or more C₁-C₁₀-alkyl radicals, C₆-C₂₀-aryl, C₇-C₂₀-alkylaryl or C₇-C₂₀-arylalkyl and may contain one or more heteroatoms of groups 13-17 of the Periodic Table of the Elements or one or more unsaturated bonds, or the two radicals R⁶ may be joined to form together with the atoms connecting them a saturated or unsaturated C₅-C₂₀ ring,
R⁷ are identical or different and are each, independently of one another, halogen or linear or branched C₁-C₂₀-alkyl, C₃-C₂₀-cycloalkyl which may be substituted by one or more C₁-C₁₀-alkyl radicals, C₆-C₂₀-aryl, C₇-C₂₀-alkylaryl or C₇-C₂₀-arylalkyl and may contain one or more heteroatoms of groups 13-17 of the Periodic Table of the Elements or one or more unsaturated bonds.

7. Catalyst prepared by a method according to claim 1.
